(19) United States
(12) Patent Application Publication
(10) Pub. No.: US 2007/0151134 A1
(43) Pub. Date: Jul. 5, 2007

(54) Menuboard with visually integrated animated and static portions

(75) Inventors: Paul Steinbrenner, West Bend, WI (US); Dawn M. Pankow, Wauwatosa, WI (US)

Correspondence Address: QUARLES & BRADY LLP, 411 E. WISCONSIN AVENUE, SUITE 2040, MILWAUKEE, WI, 53202-4497, US

(73) Assignee: The Howard Company, Inc.

(21) Appl. No.: 11/325,663

(22) Filed: Jan. 4, 2006

(51) Int. Cl. G09F 13/00

(52) U.S. Cl. 40/541

(57) ABSTRACT

A modular combination video and static display menuboard provides a display surface partially occupied by a compact LCD screen, the remainder of which is filled with a conventional backlight and frame for holding photographic and similar films for display. A self-contained video source allows the module to be freely interchanged with conventional backlighting modules without the need for special wiring or routing of video signal.

### CROSS-REFERENCE TO RELATED APPLICATIONS

### STATEMENT REGARDING FEDERALLY SPONSORED RESEARCH OR DEVELOPMENT

### BACKGROUND OF THE INVENTION

The present invention relates to backlit menuboards, and more particularly, to a menuboard system that may provide for video animated displays.

Particularly in fast food restaurants, there may be one or more menuboards presenting the restaurant menu and the prices of the menu items offered for sale. Typically, these menuboards consist of a number of display panels showing photographic reproductions of the items offered for sale together with prices and descriptions. Quite often, these menuboards have backlighting to illuminate the translucent photographs, letters, and numbers from behind. Lamps for the backlighting may be contained in a housing behind the display panel. Ordinarily, a number of menuboards are assembled into a system providing a continuous display, for example, spanning a wall behind the service counter.

Some restaurants now provide menuboard systems incorporating video displays, such as CRT, flat panel LCD or plasma panel displays. These video displays may be connected to a remote video player to display animated pictures of food or other advertising subject matter in conjunction with menu descriptions and prices, the latter which may be incorporated into the video presentation or may be displayed in conventional menuboards nearby.

Such video menuboard systems can be quite expensive because of the large size of the video displays needed to match the size of the adjacent menuboards and because of the cost of wiring the necessary video signals as well as power to the menuboard system. For small restaurant owners, adding video to a menuboard system may be a significant burden requiring substantial remodeling and/or a new menuboard system appropriate for video. Video menuboards may also add costs in the preparation of special video programming featuring the restaurant's products.

### SUMMARY OF THE INVENTION

The present invention provides a convenient and cost effective way to add animation/video to a menuboard system. In the invention, a smaller video display is visually integrated in a single housing with conventional static display elements holding photographs, letters and numbers. Matched backlighting creates the visual impression of a much larger panel whose static portion provides the necessary size and resolution to display menu descriptions and prices without adversely affecting the impact of the animated graphics.

The combined static and animated display may be added as a modular building block to other static menuboards to provide a menuboard system that permits animation/video to be added incrementally, on a custom basis, without the need for substantial upfront investment simply by replacing one of the housings.

Specifically then, in one embodiment the present invention provides a modular menuboard system having at least one display housing with a backlight and a support frame over substantially the entire front face of the display housing to hold static display elements in front of the backlight, and further having at least one second display housing also having a backlight and a support frame for static display elements, but where the static elements cover only a portion of the backlight, and an LCD panel covers the remaining portion of the backlight. Rear facing mounting elements on the housings hold the housings to a set of wall supports, for example, horizontal tracks, and a series of electrical jumpers may extend between the housings to provide for sequential electrical connection among backlights.

It is thus one object of at least one embodiment of the invention to provide for a modular menuboard system allowing incremental addition of animation/video capabilities.

It is a further object of at least one embodiment of the invention to provide for the aesthetic appeal of large displays with relatively lower cost video components.

The backlight may provide an identical color of light to the static display elements and the LCD screen.

Thus it is another object of at least one embodiment of the invention to provide the illusion of a single large video display having a portion dedicated to static information.

The first and second portions of the housing dividing the static and video sections may be opposed along the longest dimension of the housing with the longest dimension of the LCD panel along the second longest dimension of the housing.

Thus it is an object of at least one embodiment of the invention to provide a display panel having a similar aspect ratio to standard video panels when formed partially of a video panel and partially of a static backlit section.

The first and second portions may be upper and lower portions of the housing with the second element in a lower portion of the housing.

Thus it is an object of at least one embodiment of the invention to place the video animation in a dominant upper portion of the housing visible from a greater distance and the text and menu items in a lower position for better visibility to closer customers.

The first portion may be substantially half of the housing.

Thus it is an object of at least one embodiment of the invention to provide for an aesthetic balance between animation/video and static text.

The invention may include a solid-state video player fitting within the housing.

Thus it is an object of at least one embodiment of the invention to eliminate the need for expensive external wiring of video cable.

An opening may be included in the housing accessible when the housing is mounted on a wall to provide media to the solid-state video player.

It is thus an object of at least one embodiment of the invention to allow regular updating of the video material without removal of the housing.

The video player may provide an Internet connection, for example, a wireless connection to the solid-state video player.

Thus it is an object of at least one embodiment of the invention to allow for remote updating of the animation/video without the need for dedicated video cabling.

These particular objects and advantages may apply to only some embodiments falling within the claims and thus do not define the scope of the invention.

### BRIEF DESCRIPTION OF THE DRAWINGS

FIG. 1 is a perspective view of a menuboard system of the present invention having two housings mounted to abut on common horizontal mounting tracks, one housing holding a video and static backlit display, and the other housing being a standard static backlit display; and

FIG. 2 is an exploded perspective view of the components of the video and static backlit display of FIG. 1 showing jumpers for daisy-chain connection of the housings and backlights and an internal solid-state video unit accessible from the bottom of the housing.

### DETAILED DESCRIPTION OF THE PREFERRED EMBODIMENT

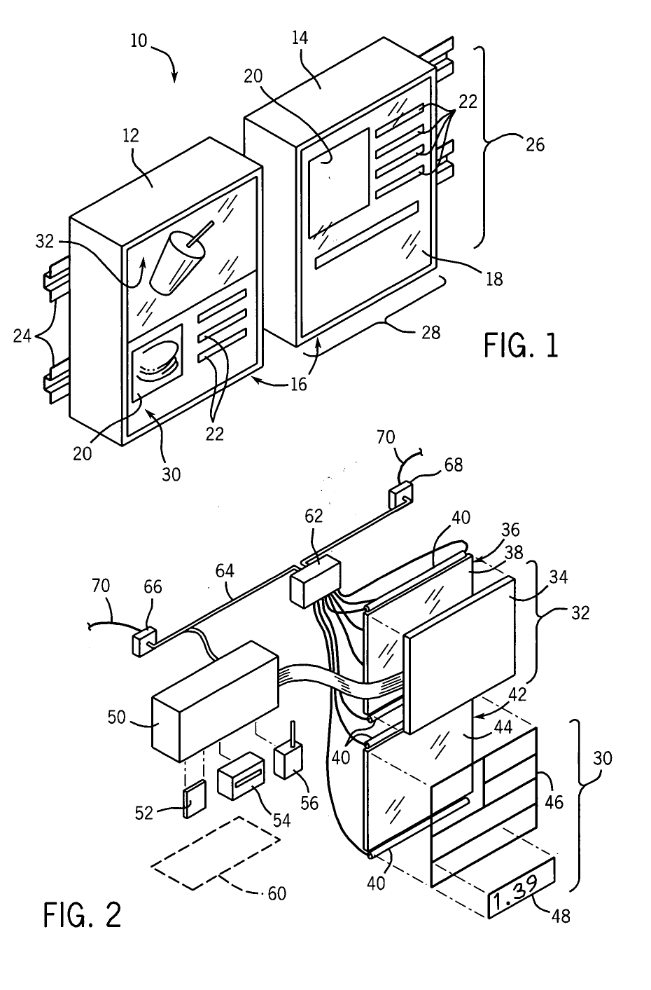

Referring now to FIG. 1, a menuboard system 10 of the present invention may provide for one or more housings 12 and 14, being the preferred embodiment, generally rectangular cabinets having front faces 16 displaying menu information. Each of the housings 12 and 14 may be attached to a pair of parallel horizontal rails 24 such as is described in U.S. co-pending application Ser. No. 11/170,580 filed Jun. 29, 2005, also assigned to the assignee of the present invention, and hereby incorporated by reference. Housings 12 and 14 may be horizontally positioned along the parallel horizontal rails 24 and individually removed and assembled to those rails 24 which may be cut to a length to support multiple housings 12 and/or 14.

In an example menuboard system 10, housing 14 may provide at its front face 16, a transparent front panel 18 behind which may be supported static display elements including pictures 20 and text and numbers 22 describing menu items. As is understood in the art, the static display elements are normally transparent or translucent film (henceforth both termed “translucent”), such as photographic film.

The static display elements are removably supported by a frame (not shown) and illuminated by a backlight (also not shown) per conventional design or as described below. Construction of backlit menuboards is known in the art and disclosed in U.S. Pat. No. 5,379,470 assigned to the assignee of the present invention, and hereby incorporated by reference.

Under a preferred mounting orientation, the housing 14 presents a longest dimension 26 as its vertical height and a second longest dimension 28 as its horizontal width.

Housing 12 has similar outward dimensions as housing 14 to be generally indistinguishable in outline. Housing 12, however, has a front face 16 divided into a lower static display portion 30 and an upper video portion 32. The lower static display portion 30 presents pictures 20 and text and numbers 22, per the housing 14, whereas the video portion 32 provides for the video display of animated product information. In the preferred embodiment, static display portion 30 and video portions 32, each occupy approximately one-half the longest dimension 26 of the housing 12.

Referring now to FIG. 2, the video portion 32 of the front face 16 of the housing 12 is occupied by an liquid crystal display (“LCD”) panel 34 arranged so that its largest dimension is aligned and commensurate with the horizontal width of the housing 12, and its second largest dimension is arranged along the vertical height of the housing 12.

Positioned behind the LCD panel 34 is a backlight unit 36 being a transparent panel providing an internally clear light guide 38 flanked on its upper and lower edges by cold cathode fluorescent tubes 40 which introduce light through the edges of the light guide 38 to be emitted from a front face of the light guide 38 toward the LCD panel 34. The light guide 38 may include reflective patterns or channels on its rear face to provide a more even illumination pattern.

A second backlight unit 42 of similar construction to backlight unit 36 is positioned in the lower static display portion 30. Instead of an LCD panel 34, a frame 46 is placed in front of backlight units 42 for receiving static display elements 48 of pictures 20 and text and numbers 22 described above. Backlight unit 42 also provides for a light guide 44 flanked on its edges by cold cathode fluorescent tubes 40 of the same intensity and color as those used with backlight unit 36.

Gaps between the backlight unit 36 and 42 may be covered with black strips of light absorbing material so as to preserve the illusion of a single display surface partitioned by video-generated masks. Accordingly, the viewer of light from the backlight units 36 and 42 perceives generally a uniform, continuous area of illumination as modified by the LCD panel 34 and the static display elements of pictures 20 and text and numbers 22 extending over substantially the entire front face 16 of the housing 12. In an alternative embodiment, a single backlight unit 36 may be used extending behind the entire height of the housing 12 enhancing the illusion of a single static display element.

A clear plastic or glass cover (not shown) may fit over the LCD panel 34 and frame 46, hinged to the front of the housing 12 to permit replacement of static display elements 48.

The LCD panel 34 may connect to a solid state video player 50 being an electronic computer storing, in solid state memory, video that may be looped and played to the LCD panel 34. The solid-state video player 50 may be wholly contained in the housing 12 so as to present no additional video wiring requirements to the user. The solid state video player may receive a memory card 52 having pre-stored video programming or alternatively, other media readers 54 such as optical disk readers or a wireless module 56 may be provided, the latter providing a communication to the Internet to receive streamed video or downloaded video over the Internet on a regular basis. For the use of a memory card 52 or other media readers 54, an opening 60 is provided in the lower surface of the housing 12 optionally covered by a removable door to allow changing of the video program without the need to remove the housing 12 from the wall and parallel horizontal rails 24.

Generally, because the housing 12 provides a distinct static display portion 30 and a video portion 32, prices and menu item descriptions need not be incorporated into the video program increasing its useful life (against changes in menu and prices) and allowing a common set of video programs to be produced and distributed to a variety of users having different specific menus. This significantly decreases the cost of video programming.

Power for a cold cathode fluorescent tube driver 62, that provides power to the cold cathode fluorescent tubes 40, and for the video player 50 may be obtained through an internal power bus 64 connecting to left and right sockets 66 and 68 exposed on the backs of the housings 12 and 14. The sockets 66 and 68 allow power to be provided to adjacent housings 12 or 14 through jumpers 70 from a single power outlet at one end of the parallel horizontal rails 24, eliminating the need for through-wall wiring or costly rewiring when the number of housings 12 or 14 are changed or a housing 12 is added.

Hooks for attaching housings 12 and 14 to the parallel horizontal rails 24, covers for the parallel horizontal rails 24 that also provide cable ways for the jumpers 70, are all described in the above-referenced co-pending application Ser. No. 11/170,580, hereby incorporated by reference. Alternatively, the housings 12 and 14 may be mounted on a serpentine track supported not necessarily on a wall as described in U.S. patent application Ser. No. 11/170,692 filed Jun. 29, 2005, hereby incorporated by reference.

Thus, referring again to FIG. 1, it will be understood that rails 24 may be mounted and populated entirely with housings 14 connected one to another to share power and eliminate the need for custom wiring. At the store owner's desire, any given housing 14 may be removed and replaced with a housing 12 providing for a self-contained video display.

It is specifically intended that the present invention not be limited to the embodiments and illustrations contained herein, but include modified forms of those embodiments including portions of the embodiments and combinations of elements of different embodiments as come within the scope of the following claims.

We claim:

1. A menuboard system comprising:
(a) at least one first display housing providing:
(i) at least one backlight held within the first display housing and providing an area of illumination over substantially an entire front face of the first display housing;
(ii) a support frame in front of the backlight over substantially the entire front face of the first display housing and holding static display elements insertable into the frame for backlighting;
(iii) rear facing mounting elements at the rear of the first display housing;
(b) at least one second display housing providing:
(i) a video panel held within the second display housing and providing a display area at at least a portion of a front face of the first display housing;
(ii) rear facing mounting elements at the rear of the housing;
(c) at least one wall support having a rear portion mountable on a wall and a front portion receiving the rear facing mounting elements to thereby support the display housings; and
(d) a set of electrical jumpers extending between display housings to provide sequential electrical connections among backlights so that power may be introduced to the menuboard system at a display housing at one end of the menuboard system and communicated to a variable number of additional display housings of the menuboard system.

2. The menuboard system of claim 1 wherein the wall support is a continuous track allow sliding adjustment of the display housing along the track.

3. The menuboard system of claim 1 further including a solid-state video player fitting within the second display housing.

4. The menuboard system of claim 3 further including an opening in the second display housing accessible when the second display housing is mounted on a wall to provide media to the solid-state video player.

5. The menuboard system of claim 1 wherein the second display housing further includes:
a backlight held within the housing and providing an area of illumination at a front face of the display housing;
a support frame in front of the backlight over a first portion of the front face of the housing holding static display elements insertable into the frame for backlighting;
wherein the video panel provides a display area over a second portion of the front face of the housing;

6. The menuboard system of claim 1 wherein the backlight in the first and second housings provides an substantially identical color of light as provided by the video panel.

7. The menuboard system of claim 5 wherein the first and second portions of the housings are separated along a longest dimension of the housing with a longest dimension of the video panel along the second longest dimension of the housing.

8. The menuboard system of claim 5 wherein the first portion is an upper portion of the front face of the housing, and the second element is a lower portion of the housing.

9. A menuboard display unit comprising:
a housing;
at least one backlight held within the housing and providing an area of illumination at a front face of the display housing;
a support frame in front of the backlight over a first portion of the front face of the housing holding static display elements insertable into the frame for backlighting;
a video panel in front of a second portion of the front face of the housing;
rear facing mounting elements at the rear of the housing; and
at least one wall support having a rear portion mountable on a wall and a front portion receiving the rear facing mounting elements to thereby support the display unit.

10. The menuboard display unit of claim 9 further including at least two jumper connectors adapted to receive jumpers extending between other display units to provide sequential electrical connections among the display units so that power may be introduced to a menuboard system at a display unit at one end of the menuboard system and communicated to a variable number of additional display housings on the menuboard system.

11. The menuboard system of claim 9 wherein the wall support is a continuous track allow sliding adjustment of the display housing along the track.

12. The menuboard display unit of claim 9 wherein the video panel is an LCD screen, and the backlight provides a substantially identical color of light to the static display elements as from the LCD screen.

13. The menuboard display unit of claim 9 wherein the first and second portions of the front face are vertically opposed within the housing.

14. The menuboard display unit of claim 12 wherein the first portion is an upper portion of the front face of the housing, and the second portion is a lower portion of the front face of the housing.

15. The menuboard display unit of claim 12 wherein the first portion is substantially an upper half of the housing.

16. The menuboard display unit of claim 9 further including a solid-state video player fitting within the housing.

17. The menuboard display unit of claim 16 further including an Internet connection providing an Internet connection to the solid-state video player.

18. The menuboard display unit of claim 16 further including a opening in the housing accessible when the housing is mounted on a wall to provide media to the solid-state video player.
